(19) United States
(12) Patent Application Publication
(10) Pub. No.: US 2013/0031155 A1
(43) Pub. Date: Jan. 31, 2013

(54) ELECTRONIC FILE SHARING

(71) Applicants: Janine T. Terrano, Gig Harbor, WA (US); Christopher J. Lacina, Port Orchard, WA (US); John Haager, Bonney Lake, WA (US)

(72) Inventors: Janine T. Terrano, Gig Harbor, WA (US); Christopher J. Lacina, Port Orchard, WA (US); John Haager, Bonney Lake, WA (US)

(73) Assignee: TOPIA TECHNOLOGY, INC., Tacoma, WA (US)

(21) Appl. No.: 13/490,147

(22) Filed: Jun. 6, 2012

Related U.S. Application Data
(60) Provisional application No. 61/493,761, filed on Jun. 6, 2011.
(60) Provisional application No. 61/604,580, filed on Feb. 29, 2012.

(51) Int. Cl. G06F 15/16

(52) U.S. Cl. 709/201

(57) ABSTRACT

An embodiment offers users the ability to search and retrieve or receive multimedia content that is indexed in a digital “catalog” stored or otherwise located in the cloud, but stored or otherwise located on client devices outside of the cloud. A user having three client devices can access, using user interface available on first device of three devices, a digital catalog, stored in the cloud, of multimedia files accessible to user. User can select from catalog a first file stored on a second device of the three devices. First file is only stored on second device, and isn't stored on a server or otherwise in the cloud. By selecting first file from catalog user can cause first file, or copy of first file, to be transferred to the third device of three devices.

### PRIORITY CLAIM

The present application claims priority from U.S. Provisional Application No. 61/493,761 filed Jun. 6, 2011 and U.S. Provisional Application No. 61/604,580 filed on Feb. 29, 2013, each application of which is herein incorporated by reference.

### BACKGROUND OF THE INVENTION

Content—information—today is being created or modified at rates unimaginable by yesterday's users. Processes and projects are faster and more immediate, whether it's time-to-market expectations for software products or the availability of real-time commentary via live blogging a political debate. Referring to FIG. 1, whether human, hardware, or virtual, the resources to do things like solve problems, search databases, crunch numbers, or answer phones are almost never centrally located-they are distributed.

Already inhibited by existing security, ad hoc, and “me-to-me” challenges, current file transfer options become even less effective when confronted with today's massively-increasing content, accelerated or immediate timeframes, and distributed resources. This paper investigates the viability of existing file transfer options in that environment.

File transfer—or information/file sharing—is an enduring requirement of almost all computer users. And although a fairly well defined set of requirements exists, no single solution meets all requirements—and some requirements have hot been adequately met at all. Chief among these problem areas are security, support for ad hoc file extra-organizational transfer, and so-called “me-to-me” file sharing and synchronization, also shown as personal information management (PIM).

These challenges may become even less tractable, as they must now perform in an evolving environment where distributed collaboration groups expect to be able share high-volume, rapidly changing information immediately and repeatedly with new, “untrusted” members. The number of email messages alone was expected to double and the average daily email traffic (MB sent and received) to increase; by 25% between 2006 and 2010 (Sun Microsystems 2009). And that estimate doesn't cover the current and future increases as collaborators decentralize and distribute. Finally, the acceleration of processes and projects both relies on and itself generates new and updated information that must be shared with partners, vendors, and customers at higher volumes under tighter time constraints.

Email, FTP—file transfer protocol, MFT—managed file transfer, SFT—secure file transfer (in hardware or virtual implementation), and web-based file, hosting and pick-up services can all perform the basics of file transfer. Referring to FIG. 2, none meets all major file transfer requirements.

None of the tools illustrated in FIG. 2 was designed to support “me-to-me sharing” between different computers used by one person or to synchronize files across those machines. The former means that a user can access the same files from different computers-her desktop at work, her notebook at home, for example, or even between, different device types. The latter, file synchronization, ensures that the files exist in the same form and version on all registered machines. Together with other activities, these functions are called personal information management (PIM); A recent study indicates that ˜70% of office workers transfer files between their different computers using a USB drive, through a network storage service, or by emailing copies to oneself. The risks of using email are the same as for all file transfers; USB drives break, don't transfer large files well, and get lost easily; and network storage services are costly, are only available when a user is connected to the Internet, and may not be accessible by different devices.

The problem of information management, which includes information access, which includes information sharing, is that it's not one problem. Here, we're interested in technology that attempts to optimize the usefulness of captive information by enabling users to search for and find, move, share/transfer, and update content files.

Some requirements are more successfully met by current solutions than others, and some are intractable.

Most solutions fail in an environment with a few, much less all, environmental confounders like the ability to work with voluminous, distributed information and to enable cross-device access, support for ad hoc file transfer, diverse security requirements, and fast accessibility.

Interestingly, as processes like high-speed computing, groups and collaborative teams, and entire industries like the electric power utilities grow more distributed, solutions for information storage—which has become unfortunately synonymous with information access—almost uniformly force users to aggregate their information in a single (if often virtual) place—the cloud. Even among those less willing to store, their information with a cloud service, single-location storage and archiving services are the norm.

Given a certain volume of information, single-location storage, while searchable, will fail when fast search and retrieval of a few files; is needed, or if other dynamic management tasks like updating are required.

Some cloud storage systems support limited cross-device access, others none at all.

No known cloud service offers users the ability to search content that is indexed and located outside the cloud.

More traditional information management, access, and sharing tasks are performed by solutions ranging from email attachments to managed and secure file transfer (MFT/SFT) systems. None of these solve any of the challenges except those of file transfer, and not even all of those, at that.

These tools were not designed to support “me-to-me sharing,” which is characterized by transferring files across device types and on different networks. File synchronization, also been a requirement for me-to-me information sharing, is required, because when files are copied to different deuces, often only the copy on the then-local device is updated, causing versioning nightmares. Several of the cloud and MFT solutions do support file synchronization.

Neither are email and file transfer solutions designed to support access to information, by and from different devices and at different locations. This ability would have been perceived by many developers as giving sustenance to the enemy (or at least free advertising to the competition). Because security is by and large imposed as part of the solution technology on its users and their files in the aggregate, file sharing becomes inflexible and again hampers ad hoc performance. Global access to solution technologies is fairly well supported—until one of those distant users can only use a device that isn't supported by the solution or doesn't meet security requirements for access.

What becomes clear in this plural-problem area, is that there are no existing single solutions for its challenges, and the way a solution meets one challenge very often renders it unable to meet another.

### BRIEF DESCRIPTION OF THE DRAWINGS

Preferred and alternative embodiments of the present, invention are described in detail below with reference to the following drawings.

FIG. 1 is a schematic view of distributed resources;

FIG. 2 is a table of file-access techniques;

FIG. 3 is a functional block diagram illustrating elements of a system according to an embodiment of the invention;

FIG. 4 is a screenshot of a workspace according to an embodiment of the invention;

FIG. 5 is a schematic, view of distributed resources according to an embodiment; and

FIGS. 6-9 illustrate a schematic view of file access according to an embodiment.

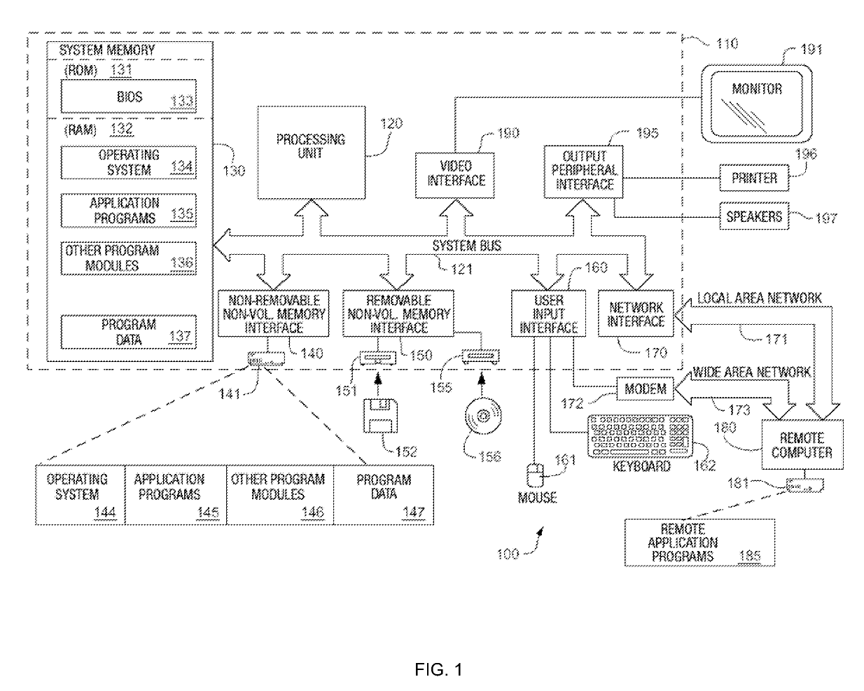

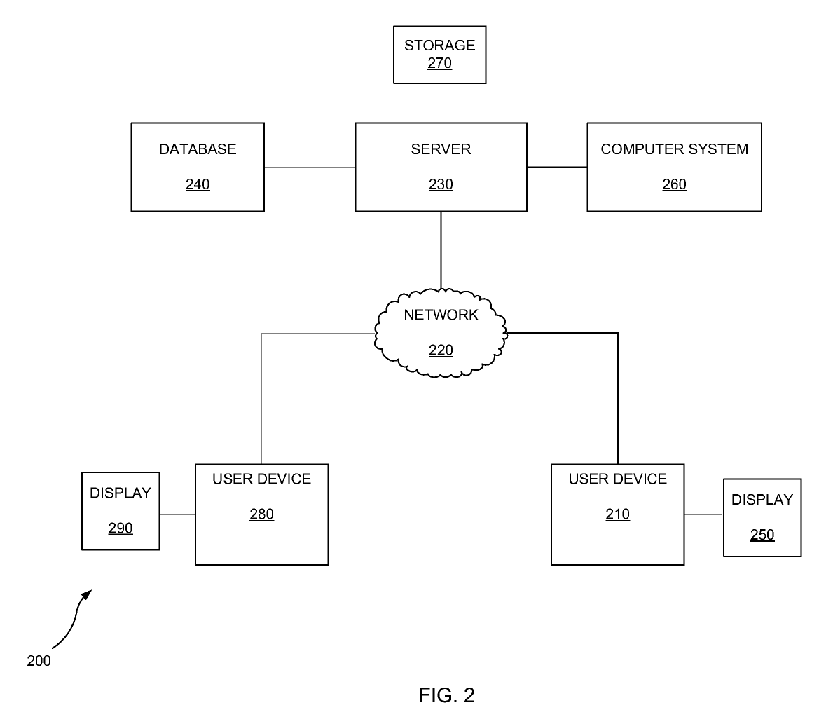

### DETAILED DESCRIPTION OF THE PREFERRED EMBODIMENT

Embodiments of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not; limitation, computer readable media may comprise, computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal, that has one or more of its characteristics set or changed in such a manner as to encode information in the signal. By way of example, and not limitation, communication, media includes wired media such as a wired network or direct-wired connection and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing, software or computer-executable instructions. Additionally, it is to be understood that a first set of data input to a processing device during. Or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence or or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions, and does not, other than the establishment of user preferences, require manual effort.

An embodiment of the invention leverages remote programming concepts by utilizing processes called mobile agents (sometimes referred to as mobile objects or agent objects). Generally speaking, these concepts provide the ability for an object (the mobile agent object) existing on a first (“host”) computer system to transplant itself to a second (“remote host”) computer system while preserving its current execution state. The operation of a mobile agent object is described briefly below.

The instructions of the mobile agent object, its preserved execution state, and other objects owned by the mobile agent object are packaged, or “encoded,” to generate a string of data that is configured so that the string of data can be transported by all standard means of communication over a computer network. Once transported to the remote host, the string of data is decoded to generate a computer process, still called the mobile agent object, within the remote host system. The decoded mobile agent object includes those objects encoded as described above and remains in its preserved execution state. The remote host computer system resumes execution of the mobile agent object which is now operating in the remote host environment.

While now operating in the new environment, the instructions of the mobile agent object are executed by the remote host to perform operations of any complexity, including defining, creating, and manipulating data objects and interacting with other remote host computer objects.

File transfer and/or synchronization, according to an embodiment, may be accomplished using some or all of the concepts described in commonly owned U.S. patent application Ser. No. 11/739,083, entitled “Electronic File Sharing,” the entirety of which is incorporated by reference as if fully set forth herein.

One or more embodiments of the invention, or components thereof, may be referred to herein using the designation “Skoot®” or “Skoot.” One or more features of one or more embodiments of the invention may be referred to herein using the designation “CloudView.”

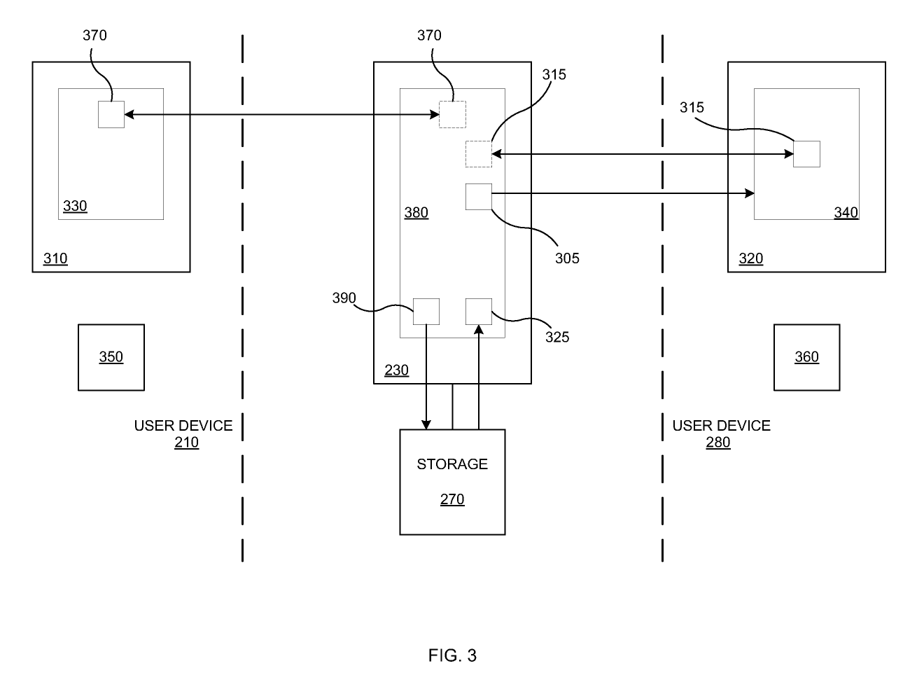

Referring to FIG. 3, designed to model multiple user workflows—a file transfer workflow, to name one—Skoot is a powerful, flexible file transfer application with both a desktop client and a web interface. A hosted server and an account administration site comprise the rest of Skoot's 4-component architecture.

When people share files, they must also share a conceptual/virtual “holding area” where files are organized. In the Skoot application, the holding area concept is implemented as an electronic workspace within the file transfer workflow.

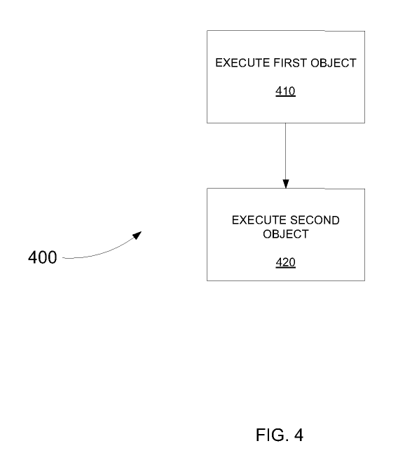

Referring to FIG. 4, Skoot was designed to support immediate use by new members—without IT support, application training, or having to learn new commands. To share files, Skoot users drag and drop the relevant files—virtually any size and/or type—into a workspace; then, they drop in the email addresses of those with, whom they want to share. Immediately, files are securely uploaded and transferred to all workspace members as they log in to Skoot on their desktop or by accessing the Skoot web client.

By modeling user workflows, Skoot's creators not only attained high usability, they also successfully implemented a tool that mirrored its performance environment. Today, this means that Skoot:
uses workspaces to perform ad hob file sharing for dynamic, collaborative groups
controls access to workspaces and secures all files using end-to-end encryption, SSL encryption, and SQL protection, and supports corporate firewalls.
is platform-agnostic and can be accessed using different devices.

Skoot reclaims the power of ad hoc's literal definition, “to this”: a Skoot user creates a specific workspace that correlates to a specific purpose issue, or situation; there is no IT set-up time or expertise required, thus no undue waiting. The workspace owner can also modify workspace details like adding or removing files in the workspace, or removing current or inviting new people to the workspace. The workspace owner—or any Skoot subscriber—can also create additional workspaces with different members and shared content. Skoot's design implies that all workspaces, thus all Skoot file sharing, are ad hoc, which is a major differentiator over other file sharing tools.

Because the service involves both transmitting private information—the files being shared—and accessing subscriber and recipient-only computers/networks, Skoot's security strategy is comprehensive, including:
adherence to subscriber's organization IT policies, works with company firewalls
username/password authentication, invitation-only access
Transportation Layer Security (TLS) encrypted sockets to prevent external parties from interpreting transmissions over the line and which initiate new keys for each connection
isolate users' data and processes from each other
log all transactions and all database interactions

Skoot's security obviates the risks associated with sharing files using FTP or email attachments.

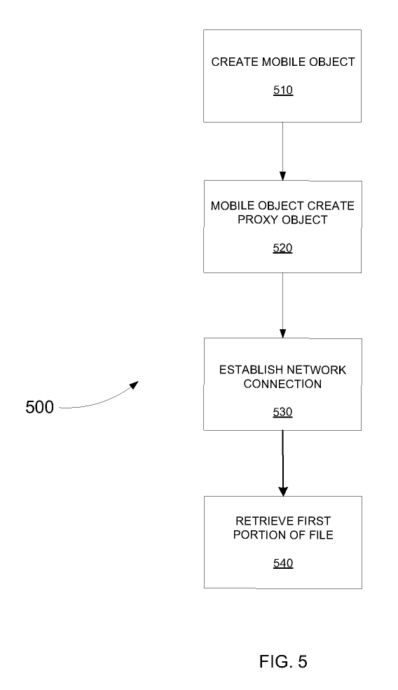

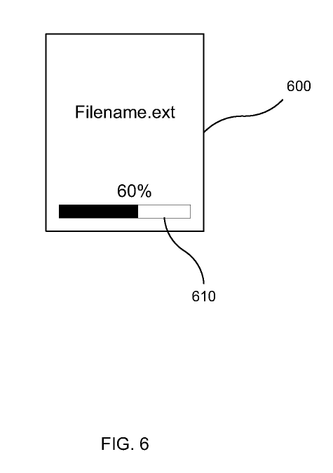

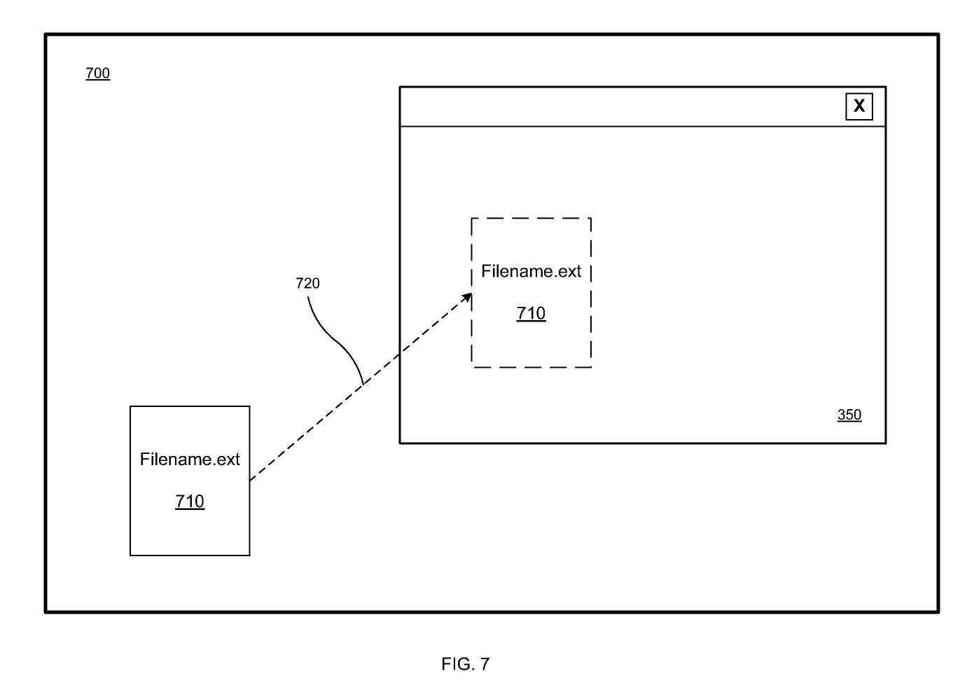

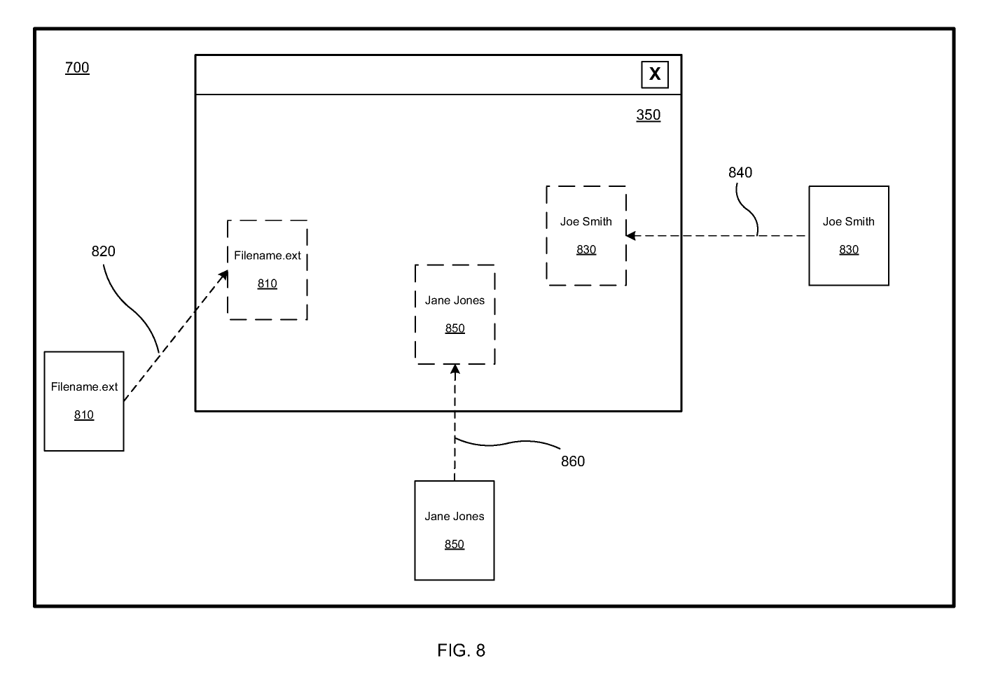

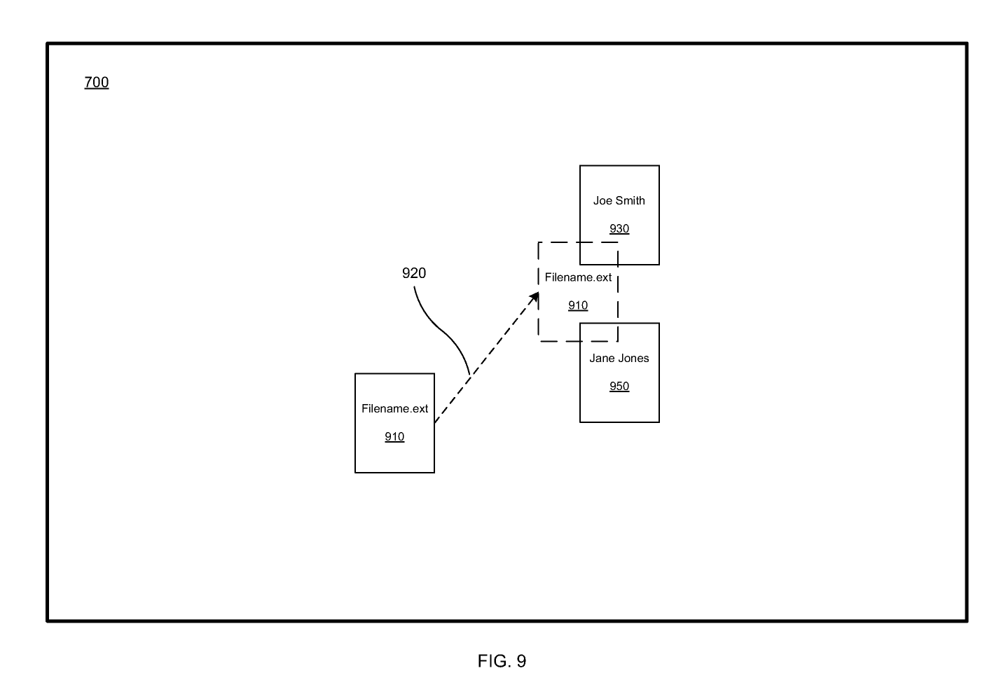

Referring to FIG. 5, Skoot also models the “me-to-me” file sharing workflow, which is also called “data synchronization between devices.” Skoot workspaces, and the files they include, can be accessed from Mac and PC computers as well as by any smartphone. The data synch (me-to-me) workflow means that the data are exactly the same across all devices. After changes are made and saved to files within the workspace, Skoot automatically updates all members' data. This eliminates the email-self contortions and risky use of USB drives to back up files or move them between work and home computers.

Skoot is an easy, secure, and reliable way to transfer large files of any type across the Internet. The workspace design feature speaks familiarly to users, and Skoot's small footprint (in system requirements and in those it imposes on subscribers) positions the service well for small-to-medium organizations. Skoot was designed to extend beyond file transfer service and is poised to co-evolve with its replacement idiom.

Content. Social networking, Web 2.0, and composed media applications are but few of today's mass content generators, and businesses and schools have more, and bigger, in the pipeline. Speed. Most of that user-generated content posts in near real-time, and the individual development projects within those and other pipelines are running fast and lean, from rapid prototyping to shorter time-to-market. Distributed. And the teams working those projects are more widely dispersed than ever before. Together, these conditions represent a challenging environment for information and file sharing. The old stand-bys of email and FTP no longer meet reliability, performance, or security requirements; newer options like MFT and SFT are both expensive and disruptive, often requiring custom integration into a client's IT infrastructure, Skoot is a suitable choice for inclusion in telecom bundled services, as an auditable service for small to medium businesses facing compliance requirements, and for regional infrastructure and emergency service's connecting local, state, and federal agency teams.

An embodiment of the invention includes these modular components:
File transfer servers
Client applications: desktop, web, and mobile
Administrative web applications: user and enterprise

Skoot's file transfer servers perform all functions preferred to share information securely both within and outside a trusted network.

Skoot subscribers can use all of the client application options, and usually, make the selection based on device and connectivity. The desktop application resides on that user's local hard drive and can be accessed and used without Internet connectivity. The web client application opens in standard browsers and may require an open Internet connection; the mobile client is basically a smaller version of the web client that opens on smartphones.

Administrative web applications are the enterprise system administrator's maintenance tools for Skoot. The user application allows addition of new accounts and amendment of existing accounts; the enterprise administrative application allows full visibility into use statistics, reporting tools, audit logs, and system settings.

An embodiment, system is compact and modular, for both security and usability. Skoot file transfer implements an information-sharing paradigm centered on the creation and use of Skoot workspaces, which start out as—empty—virtual shelves for that Skoot subscriber's files. There are practically no limits to workspace size or quantity, nor any limit to the size of the files within a workspace.

Preferred elements of Skoot file; transfer are described below from three Skoot vantage points: user, security officer, and administrator.
Logging in;
Creating workspaces;
Inviting users to workspaces; and
Adding content to workspaces.

Skoot File Transfer—User Perspective

Skoot User #1 wants to share content file F with Co-worker X. These steps may be followed to achieve this objective:

User #1: logs into Skoot desktop, web, or mobile client application;
: creates a new workspace named J;
: invites Co-worker X to join workspace J; and
: adds content file F to workspace J.

Co-worker X: joins workspace J, and Content file F begins downloading to his machine immediately.

Skoot File Transfer—Infosec Perspective

During those processes—login, create, invite/accept, and add/receive—Skoot security ensures one or more of the following conditions, using a corresponding method/technique.

| Condition | Technique |
|---|---|
| User #1 is who he says he is | authentication, encryption |
| User #1 has send privileges | authorization |
| Content file F is present on user #1' s | verification |
| machine where it is supposed to be | |
| Co-worker X is really Co-worker X | authentication, encryption |
| Co-worker X wants to receive content file F | PKI encryption |
| Content file F is chunked | encryption |
| Content file F is encrypted | encryption |
| Content file F is uploaded to Skoot server | non-repudiation |
| Content file F is in the correct location(s) | separation |
| Co-worker X is really Co-worker X | authentication |
| Content file F is downloaded | non-repudiation |
| Content file F is decrypted (encryption) | encryption |
| Content file F was not altered during | validation |
| transmission | |

Skoot File Transfer: Administrator Perspective

Enterprise sysadmin: Ensures that Skoot User #1's account information is accurate;
: Adds co-worker X account; and
   : Creates system activity report based on User #1 audit log.

For file transfer solutions, security threats fall into a fairly clear typology: attempts to access information without authorization; attempts to shut down or disrupt the service; and attempts to infiltrate an end point or a specific network node.

Attempts to gain unauthorized access can be very active or almost completely passive; examples include man in the middle (active); eavesdropping/sniffing (passive); and insertion/replay (passive-active).

Examples of attempts to shut down or disrupt the service include denial of service/distributed denial of service attacks and malware. Examples; of attempts at network infiltration also include denial of service/distributed denial of service attacks and malware.

It's important to remember that a secure file transfer system may not only prevent these attacks on itself, it may also be sure not to introduce new or heighten existing threats to either its users, their network, or the infrastructure connecting them, however briefly, while information is being transmitted.

Attempts to gain unauthorized access to information can be aimed toward any system facet that interfaces with the Internet or anything outside the trusted network. As such, an embodiment has three potential attack surfaces: its file transfer servers; web interface; and mobile client.

Man in the middle, eavesdropping, and insertion and replay all involve the attacker introducing something foreign between Skoot (web server) and endpoint (file sender/recipient), which means these attacks threaten one or more of Skoot's exposed surfaces. Skoot transfers data using TLS over HTTP, which is proof against these attack types. As well, even were TLS successfully breached, Skoot also transfers files in “chunks” that are AES-encrypted during transit and by AES-128 when on a Skoot server. AES keys are transferred to recipients separately. Keys are encrypted using each recipient's PKI keys to protect them from interception.

Skoot chunks and encrypts files being transferred before they leave the sender's machine. The encrypted chunks of the file are stored on the Skoot server in encrypted form, with filenames that are unrelated to the original file name. The file chunks are not decrypted or reassembled until they are on the recipient's machine and the recipient has been authenticated and his access has been authorized. An additional benefit of tin's “chunk and encrypt” method is that the file size that Skoot can transfer is not limited by OS capacity.

This additional, encryption means that when data arrives at the Skoot file transfer servers, they remain encrypted and unintelligible; despite the fact that SSL/TLS has automatically decrypted its encryption as part of its standard operations. Skoot's additional PKI encryption and “chunking” of files and the fact that they remain thusly scrambled while resident on Skoot's servers, significantly extends the benefits and utilities of end-to-end encryption limited to SSL/TLS. It also ensures that the Skoot services themselves are not a threat—they never have possession of a file in intelligible form.

Because it operates behind the enterprise firewall, Skoot is an unlikely direct target for denial of service and distributed denial of service attacks. The risk; of these attacks is mitigated by the enterprise, the network resources of which are more likely to be targeted by these attacks.

Because Skoot both transmits and stores data in encrypted chunks, the main risk associated with malware is effectively addressed on the buffer, because the malware file may never exist in its executable form mere. As well, current anti-malware tools work with Skoot, which eventually writes files to disk like any other application.

Insider attempts at unauthorized access are similarly thwarted by the chunked, encrypted nature of the data at rest on Skoot servers.

Skoot is also designed using tenets of separation. User data are stored separately from application and content data, as is the account administration application. All communications coming or going from the service are both monitored and logged. In addition, Skoot is itself “separate”, existing behind the enterprise firewall.

Skoot services cannot compromise file content.

Skoot captures and stores an audit log in the form of complete records of system activity. Skoot auditing meets diverse regulatory requirements as well as being able to verify the timing, occurrence, and identities related to specific system events. This verification along with digital signatures comprises Skoot's support for non-repudiation.

Skoot also provides reporting in various output formats and allows export of audit logs to the enterprise system.

An embodiment may be configured to suggest rational, functional security policies to be governed at the enterprise level. Policies should improve security-related behaviors, increase awareness of risk, and help make ad hoc file transfer less lax. People are critical risks to file transfer security and should be educated and trained and policies should be monitored for relevance.

Identity fraud is another way attackers attempt to gain access to information. Skoot protects against this by requiring authentication at multiple points in its component, file transfer processes—before authorization. That is, Skoot verifies who you are before checking whether you have permission, to perform a certain action. Authentication-related communications are often themselves encrypted, as well as being protected by multiple layers of symmetric and asymmetric key encryption.

Skoot uses separation to secure its application code using an IP address firewall lock to control access. Actual access may require the developer to VPN directly to the code using a computer that cannot have any other applications or windows active/open.

Key escrow. Finally, security for electronic data faces the purely human conundrum of how to authenticate an entity when that entity has forgotten/lost its identity-establishing password/key. Skoot includes support for an enterprise key escrow service that may be performed by a trusted enterprise officer.

The enterprise client may identify such an appropriately trusted official to become the Escrow Authority. Tin's person may be able to access an offline, or hardcopy list of individual private keys to replace one that has been lost or forgotten.

Skoot security complies with these Federal Information Processing Standards (FIPS):
FIPS PUB 198-1: Keyed-Hash Message Authentication Code.
FIPS PUB 197: Advanced Encryption Standard (AES), which specifies a FIPS-approved cryptographic algorithm that can be used to protect electronic data.
FIPS PUB 196: Entity Authentication Using PK Cryptography, which is two challenge-response protocols for computerized entities to authenticate identities.
FIPS PUB 186: Digital Signature Standard, which covers non-repudiation.
FIPS PUB 180-3: Secure Hash Standard (SHS), which is five Hash algorithms to generate digests of messages.

The challenges associated with securing, the processes, data, systems, infrastructure, and even user behaviors that are directly or tangentially involved in file transfer are neither few nor fleeting. An embodiment addresses known security risks by implementing security best practices and standards and anticipates the next generation of attacks.

Skoot is itself effectively hardened against man-in-the-middle and similar attack techniques; as well; it cooperates as seamlessly with endpoint systems in their fight against brute force attacks on encrypted, data as it does when helping an enterprise mitigate the damage caused by malware.

Alternatively, rather than imposing Skoot-generated security policies on an enterprise with a much wider purview, an embodiment enables enterprise clients to create an effective enterprise security policy into which Skoot security practices integrate cleanly.

For information to be useful, it must first exist and it must be accessible. And because today's definition of accessible includes allowing users to search for, find, move, share, secure, and change information, that's a significant requirement.

Not surprisingly, entire industries—and governmental organizations—have formed around the component parts of information access—like information, sharing—and its even more inclusive parent capability, information management. This application focuses on how well, today's technology solutions meet the challenges of supporting both me-to-them and me-to-me information-sharing needs, as well as aspects of information accessibility and management, in today's computing environment.

These challenges include an operational environment characterized by: multiple new device forms, operating systems, and platforms; entirely new computing models—cloud, mobile; global user populations; dynamic, mobile, and ad hoc networks; multiple levels of security; massive information/volume and rapidly increasing file sizes; distributed machines, processes, and teams; and near-real-time performance and availability requirements.

Again, not surprisingly, there is no single, technology or solution to these challenges, and enterprises most often integrate and deploy a combination of products and services to meet them.

Powerful File Transfer

Skoot secure file transfer performs a broad range of information sharing tasks, including, but not limited to:
Transfer of any type and any size file
Universal access via a desktop client, a mobile, client, and a web interface
Cross-device, platform-agnostic file access and transfer
Invitation-only workspaces where members drag-and-drop content for immediate transfer to other members
Broadcast workspaces where a central authority pushes content to receive-only nodes around the world
Secure file transfer and sharing with untrusted/unknown entities

Skoot's architecture is lean, comprising, preferably, a hosted server, an account administration site, a web interface, and optional desktop and mobile, clients.

Designed to support immediate use by new members—without IT support, application training, or having to learn new commands, Skoot file transfer involves, preferably, 3 steps.

In an embodiment, to share files, Skoot users create a workspace (step 1), drag and drop the files they want to share into that workspace (step 2), and drop in the email addresses of people they want to share mat information with (Step 3). Files are immediately, securely transferred to all workspace members as they log in to Skoot locally or on the web.

Secure Information Sharing

Skoot was developed to, prevent known attacks like man-in-the-middle, distributed denial of service, and sniffing. Skoot's architecture, components, and processes are also implemented to anticipate and prevent more innovative attacks.

A foundation of Skoot security is strong in encryption, authentication, and separation, effectively preventing unauthorized access to both the system and file content. Data is encrypted end-to-end during transmission and while stored in the Skoot cloud. So, no file buffered in the Skoot cloud or being transferred to or from a workspace ever exists in a vulnerable or readable form.

In addition, Skoot's comprehensive auditing tool logs all system events and supports flexible reporting and output formats that meet a range of compliance and non-repudiation needs.

Comprehensive File Access, Transfer, and Management: Skoot with CloudView

CloudView empowers Skoot's unequalled me-to-me file sharing features, performing cross-device and location file search and browse, transfer, and management tasks from a single easy-to-use interface. Accessible via Skoot's desktop and mobile clients or through the Skoot web interface, CloudView allows users to search, move, and manage files residing on any of their devices—laptops, desktops, smartphones, iPads, PDAs, a network-attached storage machine—or stored in the Skoot cloud.

CloudView search offers users of multiple devices a panoramic, comprehensive view of their data and files across devices and storage locations unmatched by any other service. Without having to upload files locally, CloudView may also move files across devices, as well as update, delete, rename, and perform other file management tasks from a remote device.

An embodiment offers users the ability to search and retrieve or receive multimedia content that is (a) indexed in a digital “catalog” stored or otherwise located in the cloud, but (b) stored or otherwise located on client devices outside of the cloud. Consequently, for example and in an embodiment, a user having three client devices can access, using a user interface available on a first device of the three; client devices, a digital catalog, stored in the cloud, of multimedia files accessible to the user. Using the user interface, the user can select from the catalog a first file stored on a second device of the three client devices. Significantly, this first file is only stored on the second device, and is not stored on a server or otherwise in the cloud. By selecting the first file from the catalog, the user can cause the first file, or a copy of the first file, to be transferred to the third device of the three client devices. In this example, the three client devices may be remote from one another but communicate with one another over a network (e.g., WAN, such as the Internet, or LAN).

CloudView users can also fine-tune the availability of their data by flagging specific files as “high availability.” Using CloudView search across their devices, users locate and tag files for which availability is critical; Skoot may pre-buffer those fries securely in the Skoot cloud, ensuring their immediate availability to all authorized users, regardless of their device type or network connectivity. As with all Skoot file transfer, there are no file size, number, or type limitations, and as with all CloudView-enabled devices and locations, all files remain accessible and remotely manageable. Information can remain in high-availability status for different durations.

Information sharing involves hardware (devices used to access service and receive files), software (the interface of the service holding the file), file type (the information being shared), and security (access policies of the file owner as well as security mechanisms of the sharing service).

By supporting variable options in each of these elements, Skoot lays claim to the full power of ad hoc information access, sharing and management.

And what this means, by extension, is that Skoot users don't have to know all the details of how, or with whom they may need to share files in the future—in fact, a person who only receives files via Skoot doesn't pay anything and doesn't need a Skoot account.

Skoot securely fulfills the requirements for me-to-them information sharing with invitation-only membership to individual Skoot workspaces where files can be added, updated, and deleted as needed without encountering the versioning issues or time-consuming process of file synchronization. Skoot can be accessed from any web-enabled device, doesn't impose extraneous security requirements to receive files—but does maintain files in an encrypted form until they are fully downloaded to the recipient's machine as well as authenticating the recipient's identity and verifying their authorization to access specific files.

Skoot's CloudView feature realizes the many advantages of unified information access for its users. Because users store content where it's convenient, CloudView may index the files saved by a user on any registered device, and once indexed, all files are searchable through a single CloudView interface. Search results—files from one device or the other—can then be transferred to another device (without being uploaded to the current access device), renamed, deleted, or other wise managed through that same CloudView interface. Skoot allows users to decide where they want their files to reside based on individual preferences, access needs, security requirements, etc.

CloudView also supports an adjustable availability function that allows users to designate specific files or groups of files as “highly available.” These files are then encrypted and ‘pre-buffered’ in the Skoot cloud, making them immediately accessible—that is, searchable, move-able, manageable—to their owner, via any device, for the duration designated by the user, in the future, when a user's files held in a cloud storage service can be accessed by CloudView, this may extend immediate accessibility files stored there, the lack of which is currently a weakness in the solution.

Skoot is, highly secure, encrypting the files it transfers or buffers on the Skoot cloud at all times as well as supporting the enterprise or other security policies of the user's network and preventing damage from malicious attacks and unintentional user errors.

Skoot with CloudView offers law firms, for example, an affordable alternative to high-dollar e-discovery, document retrieval, and secure data storage services without sacrificing performance or security. The discovery process often returns an unwieldy amount of information, most of which is either retrieved in or quickly converted into digital form, reviewed for relevance, indexed in some fashion, and then archived. When there is a demand for a known file or subset of files or there is a request to verify a file's existence, the firm may request a search of the entire collection, which, if the search is successful, is then followed by retrieval of the relevant files and delivery the requestor.

Even in this distilled example, the processes described are: resource- and time-intensive if performed by firm staff; unavailable as a single commercial service; and extremely expensive when purchased as specialty services (one service for research, another document retrieval, and another secure storage).

Using Skoot with CloudView, the same scenario is more manageable, affordable, and efficient, as well as faster and potentially returning a greater percentage of relevant material. The mass of digital data can be simply indexed and stored in the Skoot cloud; each of the distinct demand types can be met by Skoot with CloudView's search capability; and retrieval is easily performed by Skoot from the cloud or any registered device; files can be delivered to any registered user or device. In cases where large subsets of potentially relevant data are identified, Skoot can also pre-buffer those files on the cloud for immediate availability.

In this scenario, Skoot with CloudView outperforms several significantly more expensive document storage, retrieval, and delivery services by enabling direct search of the files, performing immediate aid hoc transfer to and from any device indicated; and ensuring availability by pre-buffering to the cloud.

Access is a necessity in today's high-volume information and fast-paced computing environments. To leverage its full power, you may be able to search, move, share, change, and otherwise, manage your information, regardless of which device it's saved on or where you're currently storing it. Until recently, these components of “information access” were only available in separate applications, or from multiple services.

Skoot with CloudView is a secure information access transfer, and management service developed and marketed by Topia Technology, Inc. The service includes unified search of all of a user's registered devices; file movement from device to advice without intermediate file upload or requisite copying; and file management in the form of renaming, updating, deleting or otherwise revising file metadata.

Skoot with CloudView forms a powerful and comprehensive information management—access, transfer, management—tool that solves a lot of the toughest challenges in information sharing. Both me-to-me and me-to-them file transfer are fully enabled, so new devices can be used to their fullest extent, without sacrificing security or another preferred capability, or losing flexibility by requiring data to be aggregated and stored in a single, or any particular, location.

While a preferred embodiment of the invention has been illustrated and described, as noted above, many changes can be made without departing from the spirit and scope of the invention. Instead, the invention should be determined entirely by reference to the claims that follow.

The embodiments of the invention in which an exclusive property or privilege is claimed are defined as follows:

1. A method, comprising the steps of:
storing a first file on a first client device;
generating data referencing the first file;
storing the data on the server, wherein the first file is not stored on server;
receiving from a user a selection of the data;
in response to receiving the selection, providing the first file to a second client device without storing the first file on the server.
